(19) United States
(12) Patent Application Publication
(10) Pub. No.: US 2007/0274534 A1
(43) Pub. Date: Nov. 29, 2007

(54) Audio recording system

(75) Inventors: Peter Lockhart, Romsey (GB); Steven David Massie, Poole (GB); Dean Robert Thomas, Eastleigh (GB)

Correspondence Address: CROWELL & MORING LLP;INTELLECTUAL PROPERTY GROUP, P.O. BOX 14300, WASHINGTON, DC, 20044-4300, US

(73) Assignee: Roke Manor Research Limited, Romsey (GB)

(21) Appl. No.: 11/798,473

(22) Filed: May 14, 2007

(30) Foreign Application Priority Data
May 15, 2006 (GB) 0609466.8

(51) Int. Cl. H04R 3/00

(52) U.S. Cl. 381/92; 381/122

(57) ABSTRACT

An audio recording system comprises an array of microphones and a processor module. The array is a logarithmic spiral array in which the minimum distance between each microphone and all others that lie closer to the centre is maximised. The processor module further comprises a beam direction control device and a beam width control device; whereby an audio target is isolated.

### BACKGROUND

This invention relates to an audio recording system, in particular for recording a specific audio target some distance away.

There are many situations in the broadcasting industry where it is difficult, or impossible to place a microphone close to the sources of sound that are of interest. For example in the coverage of many sports events it is impossible to place a microphone close to the players. In these circumstances the broadcaster will often use “gun” microphones, which are directional gradient microphones. In the case of football coverage, there may be as many as 12 gun microphones deployed around the pitch. These microphones have a number of limitations including the fact that they have relatively modest directivity (especially at low frequencies); they need to be physically moved to pick up sound in a different direction; they are very sensitive to wind noise; and there is strong frequency coloration of the output for sources off the main axis of sensitivity arising from variations of their directivity with frequency.

### SUMMARY OF THE INVENTION

In accordance with the present invention an audio recording system comprises an array of microphones and a processor module; wherein the array is a logarithmic spiral array in which the minimum distance between each microphone and all others that lie closer to the centre is maximised; and wherein the processor module further comprises a beam direction control device and a beam width control device; whereby an audio target is isolated.

The present invention includes a logarithmic spiral array in which the minimum distance between each microphone and all others that lie closer to a centre of the spiral is maximised, which enables a particular sound source to be discriminated from surrounding sounds and then extracted, either in real time or by processing stored data. Once a particular sound source has been isolated, the array can be directed to track sound from that particular source and exclude other audio sources of less interest.

Preferably, the beam direction control device comprises a plurality of switched delay elements.

Preferably, the beam width control device comprises beam filters.

Preferably, the processor module further comprises a blocking filter; and an adaptive interference canceller.

Preferably, the processor module further comprises an adaptive blocking filter for adaptive filtering of an audio target.

An adaptive blocking filter reduces the susceptibility of the system to leakage of the audio target signal into the interference canceller (e.g. as a result of acoustic reflections) or when there are phase errors or variations in the direction of arrival across the array and so distinguishes wanted signals from reference signals fed to the interference canceller.

Preferably, the system further comprises a data store, whereby audio signals from each microphone in the array are stored for later processing.

This enables multiple signals to be recorded and the ones of interest extracted later, without the need to process multiple signals in real time.

Preferably, each microphone further comprises an analogue to digital converter and a bus interface, whereby digital data is transferred to the processor module via a bus.

This improves ease of array construction and deployment.

### BRIEF DESCRIPTION OF THE DRAWINGS

An example of an audio system in accordance with the present invention will now be described with reference to the accompanying drawings in which:

FIG. 1 illustrates a block diagram of a basic embodiment of the present invention;

FIG. 2 illustrates an example of a logarithmic spiral array for use in the present invention;

FIG. 3 is a block diagram of a preferred embodiment of the present invention; and,

FIG. 4 illustrates in more detail a microphone element for use in the example of FIG. 2.

### DETAILED DESCRIPTION OF THE PREFERRED EMBODIMENT

For the purpose of this application the term logarithmic spiral refers to an arrangement of microphones in a plane in which the density of microphones is greatest near the centre, and becomes progressively lower near the periphery.

The present invention provides an array microphone which overcomes the problems of the prior art type and provides a very versatile tool for broadcast applications. Using audio recording technology, it is possible to record large numbers of audio channels to hard disk at low cost and with high fidelity. This allows the post processing of signals from a large scale array of microphones to isolate the audio of interest.

Microphone arrays have been used in hands-free telephony and teleconferencing and have also been proposed for hearing aid applications, amongst others. For such applications, the array microphones have relatively few elements, typically 4 to 8, and are consequently limited in their performance. There have also been academic studies carried out to develop algorithms and beamforming strategies for microphone arrays. Much of the work has been based on algorithms originally developed for radar, but with adaptations to deal with the much wider proportional bandwidths associated with acoustic signals and with the complexities of acoustic propagation and of the environment (air movement, reverberation etc.).

There also exist multiple-microphone arrays for noise source measurement and characterisation. These are primarily for use by scientists and hence are very expensive and require specialist skills to understand and use. The outputs of such systems are rarely summed to produce an audible output—they are primarily used for visualising the level of acoustic signal arriving from a particular direction.

None of the research to date has concentrated on the specific requirements of broadcasters. In fact, the large scale arrays that would be needed to meet these requirements have received little attention in the research community as they have generally been dismissed as too costly. However, the cost of high quality microphone elements, analogue to digital conversion and processing has greatly reduced in recent years and is likely to continue to do so with the advent of micro-electro-mechanical systems (MEMs) microphones and increasing integration of sensing elements and digital electronics. Furthermore, although the processing could be done in real time, a system capable of carrying out timely off-line processing of recorded signals can be implemented at relatively low cost with current off-the-shelf equipment.

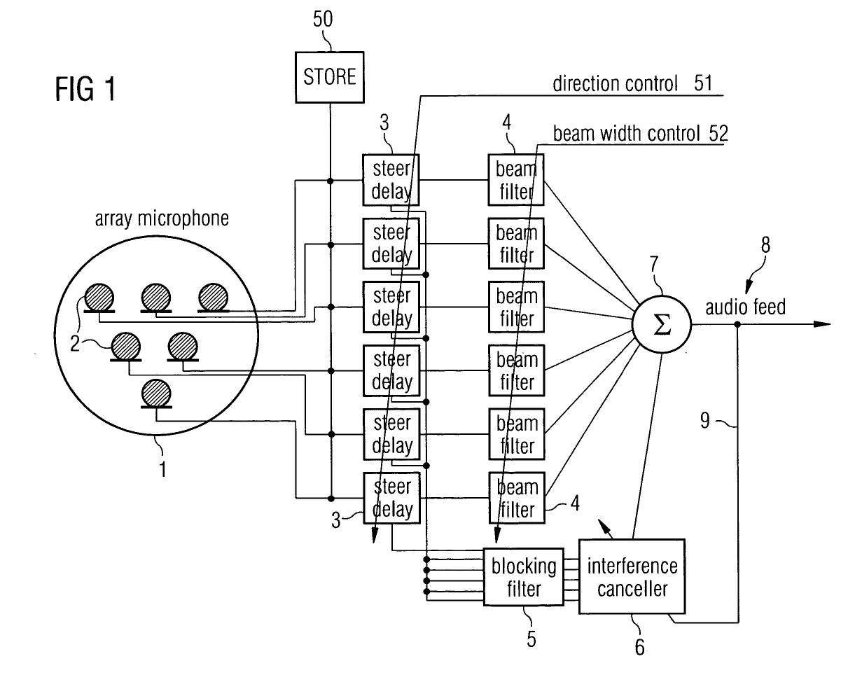

FIG. 1 illustrates the basic components of an audio recording system according to the invention. A microphone array 1 comprises a number of individual microphone elements 2 each of which provides an input to individual steer delay elements 3 which provide direction control 51. One output from each steer delay element 3 is input to individual beam filters 4 for beam width control 52 and another output from each element 3 is input to a single fixed blocking filter 5. An optional store 50 may also be provided.

The blocking filter 5 provides an input to an interference canceller 6. A summer 7 combines a signal from the interference canceller 6 with outputs from each beam filter 4 to produce an audio feed 8 and the audio feed is also returned to the interference canceller 6 to provide feedback to improve the interference cancellation. The steer delays, filters and cancellers together form a processor module.

Beamforming in a number of contexts (primarily radar) has long been posed in terms of a generalised filtering problem with coefficients in both the time/frequency and spatial domains. Furthermore, variations on the generalised sidelobe canceller have been presented that incorporate frequency dependence in the constraint (for example in Hoshuyama and Sugiyama, Robust Adaptive Beamforming, 2001). Constant directivity beamformers have also been proposed for non-adaptive arrays (Ward et al, 2001—“Constant Directivity Beamforming” In publication “Microphone Arrays”, Springer-Verlag, 2001, ISBN 3-540-41953-5). The present invention provides a microphone which combines the concept of a generalised sidelobe canceller having a frequency dependent constraint and the objective of uniform directivity over a wide frequency range which is used in the design of the constraint.

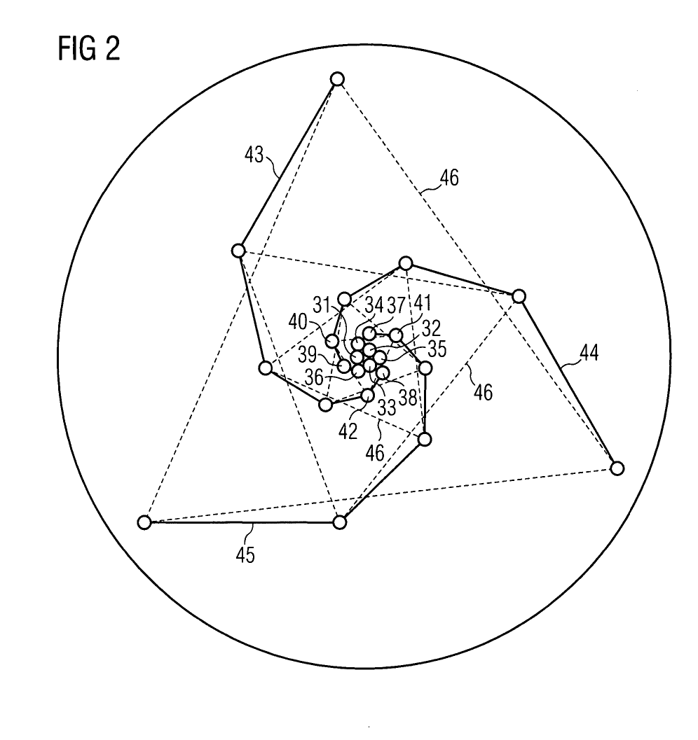

The present invention makes use of a substantially logarithmic spiral array in order to collect raw audio data from as wide a field as possible. FIG. 2 illustrates a typical logarithmic spiral array.

To construct a microphone array layout of the type shown in FIG. 2, an inner set of microphones 31, 32, 33 are arranged on the vertices of a regular polygon 46 (a triangle is used in the example of FIG. 2) and the spacing between the inner set of microphones is chosen to be less than one half of the wavelength of the highest frequency at which the microphone array is expected to operate. Additional microphones 34, 35, 36 are added by dilating the basic polygon by a fixed ratio, and rotating it so as to maximise the minimum distance between any of the new microphones and any of the microphones already placed. The ratio between the sizes of each successive polygon is chosen to achieve a desired beam width, where a smaller ratio results in a narrower possible beam. Microphones are added 37, 38, 39; 40, 41, 42 until the overall size of the array is sufficient to achieve the desired beam width at the lowest operating frequency, where a larger overall size is required for a narrower beam. This process generally results in an arrangement of microphones with an overall logarithmic spiral form, although the innermost microphones 31 to 36 may deviate slightly from this pattern depending on the ratio between the sizes of successive polygons and the number of vertices of each polygon. This process may produce either a left-handed or right-handed spiral form 43, 44, 45 and both perform equally well.

The advantage of a logarithmic spiral array designed according to the algorithm described above is that it provides for uniform directivity and sidelobe performance over an extended bandwidth. The design of the logarithmic spiral array may be further optimised by moving the position of individual microphone elements, without departing from the overall effect of the array design.

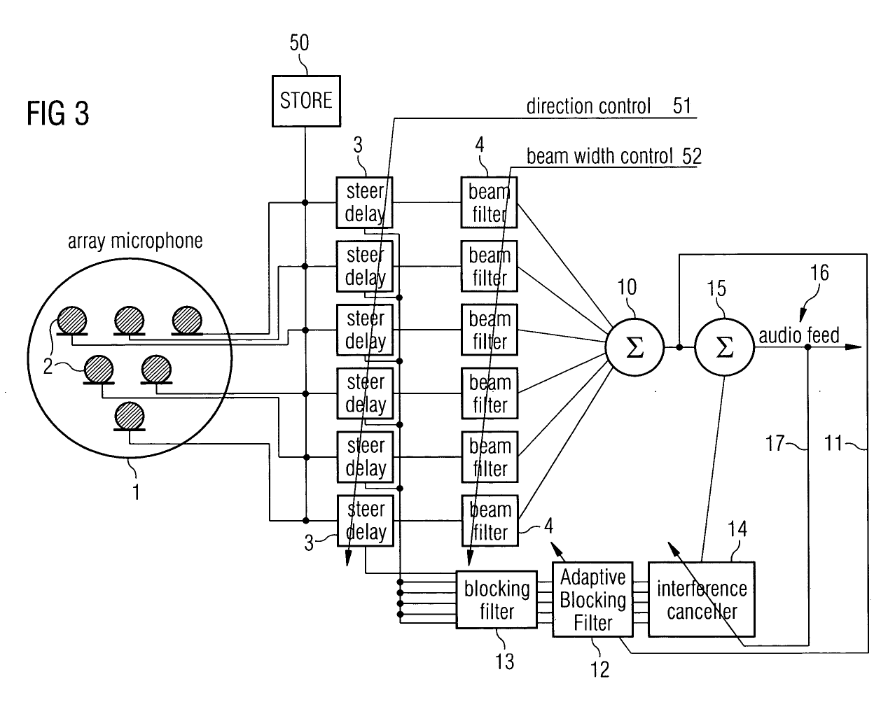

FIG. 3 illustrates a preferred embodiment of the present invention. As in FIG. 1, the system comprises a microphone array 1 in a logarithmic spiral arrangement as well as steer delay elements 3 and beam filter elements 4. Optionally, the store 50 may be provided. However, in this embodiment, the blocking filter comprises a fixed blocking filter 13 and an adaptive blocking filter 12. The output of the fixed blocking filter is passed to the adaptive blocking filter 12 and the outputs of the steer delay and beam filter elements are summed in summer 10 and the summer output provides feedback 11 to the adaptive blocking filter 12.

The role of the blocking filter is to constrain the interference canceller so that it only cancels out the unwanted, interfering signals, but does not reduce the amplitude of the wanted signal. It does this by eliminating (i.e. nulling) the wanted signal from the microphone signals to produce a set of interference reference signals. Thus, when the interference canceller uses the reference signals to cancel the interference from the output of the fixed beamformer, it does not eliminate the wanted signal at the same time. The blocking filter may, with advantage, be constructed so as to eliminate the wanted signal not only from a direct acoustic path, but also from known sources of reflection, such as the ground.

The outputs from the adaptive blocking filter 12 are input to an interference canceller 14 and the signal from the interference canceller 14 is combined with the output of the first summer 10 in a second summer 15 to provide an audio feed 16. There is also a feedback 17 of the audio feed to the interference canceller 14 to improve interference cancellation. The feedback of the audio signal and the first summation signal allow the audio output to be fine tuned to remove interference effects from sound sources that are in the direction of interest or reverberant paths from the sound source of interest (i.e. paths arriving outside of the main beam).

The present invention uses large numbers of microphone elements in a generally logarithmic spiral arrangement to provide sufficient coverage to enable a particular sound source to be discriminated, either in real time or by mean of post processing. The frequency-dependent array shading in the beamforming constraint of a generalised sidelobe canceller provides constant beamwidth over a wide frequency range.

By using an adaptive blocking matrix in place of the fixed blocking matrix used in the basic generalised sidelobe canceller (GSC) of FIG. 1, the susceptibility of the system to leakage of the target signal into the interference canceller when there are phase errors or variations in the direction of arrival across the array is reduced, as such leakage would cause the interference canceller to cancel the target signal. A fixed blocking filter, of the type that has been traditionally used in the GSC algorithm, followed by the adaptive blocking process as shown in FIG. 3 deals with residual components of the blocked signal that are still correlated with the target signal thereby providing a further enhancement.

The steer delay and beam filter forming a fixed beamformer element of the adaptive array allows a real time implementation in broadcast industry applications. To facilitate rapid steering of the array to follow the action, a number of beams filters are pre-calculated and the operator needs only to switch from one to another, with the appropriate delays switched simultaneously, in order to steer the array toward a target. Once a target has been identified by listening to the audio feed from the fixed beamformer, then the adaptation process can be switched on to further improve the signal to noise ratio. By recording all the audio data from all array elements to the store 50, such as hard disk, or at least buffering it for several minutes, the adaptive interference cancellation can be applied retroactively to any audio data in the chosen direction.

A further advantage of recording all of the array microphone element signals is that this gives the broadcaster the ability to remix the audio presentation during post production with unprecedented flexibility. Signals that had not been considered significant at the time of recording can either be enhanced for broadcast, or suppressed according to need. A single device according to the present invention can be used to generate several distinct simultaneous audio streams, where each stream represents a separate beamform derived from the same set of array element signals. By this means, all the signals needed for a variety of different multi-speaker audio presentation formats, such as stereo, quadraphonic, 5.1, etc., can be derived with only one microphone array.

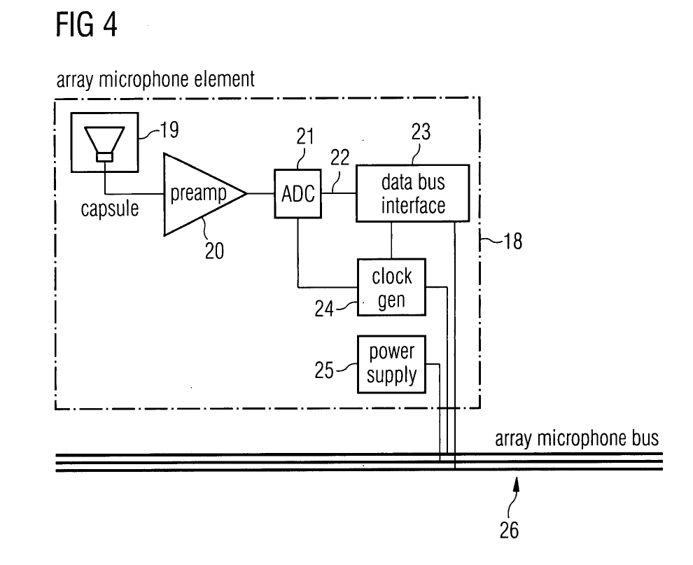

The microphone array of the present invention as applied to the broadcast industry can be made more straightforward to implement and more versatile by including in each microphone element 2 its own analogue to digital conversion and communication to the central processor unit using a standardised bus. The bus can also provide power and time synchronisation as illustrated in FIG. 4.

FIG. 4 illustrates a compact array microphone element 18. A microphone capsule 19 picks up audio signals and amplifies them in a pre-amp 20. The amplified signal is analogue to digital converted in an analogue to digital converter (ADC) 21 and the digital signal 22 is input to a data bus interface 23. The ADC clock is provided by a clock generator 24 which also provides synchronisation to a bus 26 and the interface 23. The element 18 has its own on-board power supply 25, coupled to the bus 26. In this example, the array microphone element comprises a microphone capsule, digitiser, synchronisation and communications interface and power supply, all provided in one compact unit, so that each array microphone element connects to a high-bandwidth data bus that supplies power and synchronisation to the elements, and conveys digitised audio information back from each microphone element to the central processor module. By this means, a relatively small number of connections need be provided between the microphone array and the processor module.

A particular problem with large scale arrays of this type is in calibration of the array, so it is desirable that the array is set up for autocalibration. This can be done by providing a sound source that is separate from the array, and which may be placed in a known position relative to the array. One way to achieve accurate positioning is by mounting low-powered collimated laser devices on the array such that the beams intersect at the desired sound source position. The sound source would be driven to produce a known signal, allowing the relative transfer functions between each of the array elements to be calculated.

What is claimed is:

1. An audio recording system, the system comprising an array of microphones and a processor module; wherein the array is a logarithmic spiral array in which the minimum distance between each microphone and all others that lie closer to the centre is maximised; and wherein the processor module includes a beam direction control device and a beam width control device; whereby an audio target is isolated.

2. A system according to claim 1, wherein the beam direction control device comprises a plurality of switched delay elements.

3. A system according to claim 1, wherein the beam width control device comprises beam filters.

4. A system according to claim 1, wherein the processor module further comprises a blocking filter; and an adaptive interference canceller.

5. A system according to claim 1, wherein the processor module further comprises an adaptive blocking filter for adaptive filtering of an audio target.

6. A system according to claim 1, further comprising a data store, whereby audio signals from each microphone in the array are stored for later processing.

7. A system according to claim 1, wherein each microphone further comprises an analogue to digital converter and a bus interface, whereby digital data is transferred to the processor module via a bus.
